(19) United States
(12) Patent Application Publication
(10) Pub. No.: US 2020/0332230 A1
(43) Pub. Date: Oct. 22, 2020

(54) Laundry Additive for Removing Stains

(71) Applicant: Zobele Holding S.P.A., Trento (IT)

(72) Inventors: Montserrat Riera, Barcellona (ES); Silvano Garavaglia, Trento (IT); Giovanni Carrara, Trento (IT)

(21) Appl. No.: 16/958,795

(22) PCT Filed: Dec. 13, 2018
(86) PCT No.: PCT/IB2018/060030

§ 371 Date: Jun. 29, 2020

(30) Foreign Application Priority Data
Dec. 29, 2017 (IT) 102017000151017

(51) Int. Cl. C11D 3/395; C11D 1/24; C11D 3/37; C11D 3/39; C11D 3/04; C11D 3/10; C11D 3/30; C11D 3/50; C11D 11/00; C11D 17/06

(52) U.S. Cl. CPC C11D 3/3951; C11D 3/3953; C11D 1/24; C11D 3/3707; C11D 3/3942; C11D 17/06; C11D 3/10; C11D 3/30; C11D 3/505; C11D 11/0017; C11D 3/046

(57) ABSTRACT

A water-soluble bleach additive for laundry detergents and surface cleaning detergents, of the type comprising a bleach agent, a bleach agent activator, and a builder. The bleach additive further comprises a sticky surfactant and, preferably, a water-soluble high molecular weight polymer and a plasticizer which allow to form the bleach additive in pellets through an extrusion process.

### FIELD OF THE INVENTION

The present invention relates to a bleach additive for laundry detergents, especially to be used in the laundry prewash, and for surface cleaning detergents. The bleach additive of the invention is intended to increase the effectiveness of detergents in removing stains.

### BACKGROUND ART

Compositions are well known in the art for the pre-treatment of a laundry article, e.g. for removing stains or to facilitate stain removal during the washing operation. Such compositions are, e.g., in form of powders, pellets, liquids, gels, tablets or capsules.

Detergent formulations for textiles wash must remove a wide variety of stains and dirt from different types of textiles in a wide range of washing conditions. The main components of detergent formulations such as surfactants, builders and enzymes mainly remove dirt, and oily, greasy, proteinic and particle stains.

However, modern high-performance detergents cannot yet remove certain types of stains effectively without making use of bleaches.

The term “bleaches” herein is intended to generally include all the substances and materials that are provided with useful oxidizing properties. The most widely used bleaches in laundry detergents are based on sources of inorganic peroxides, such as alkali metal perborates, percarbonates, persilicates and perpyrophosphates, which develop oxygen in aqueous solution in the form of hydrogen peroxide, or hydrogen peroxide in aqueous solution directly.

However, the afore-mentioned peroxide salts decompose rapidly if stored in a moist and/or warm environment, with two important drawbacks: purity of the peroxide salt decreases and the thermal degradation reaction is an exothermic one and produces oxygen. It is therefore possible that under not-optimal storage conditions the oxidizing material loses some of its effectiveness and, at the same time, increases its temperature by self-heating, thus accelerating its degradation. In manufacturing factories or warehouses where the oxidizing material is stored in large quantities, the liberated oxygen can also cause dangerous explosions.

However, acceptable storage conditions of bleaches can be obtained through protection of the degradable component, consisting of peroxide salts, by coating the crystalline product or by including stabilizing agents during its manufacture, or both measures simultaneously. A variety of suitable coating agents have been proposed in the known art, including silicates and mixtures of inorganic sulfates and carbonate salts.

In the publication WO-92/06163, percarbonate-containing compositions wherein the relative humidity at equilibrium and the amount of heavy metal ions must be carefully controlled to ensure percarbonate stability, are disclosed.

In patent U.S. Pat. No. 6,017,867 formulations with improved stability, based on alkali metal percarbonates with particles having a well-defined mean size and being furthermore coated with hydrophobic materials, such as hydrophobic silica, are disclosed.

In patent U.S. Pat. No. 5,374,368, materials which release hydrogen peroxide blended with a protective agent based on polyalkylene glycol and with colloidal silica, are disclosed.

The peroxide-based materials, in order to be effective, must also undergo to an activation reaction in the wash liquid to generate the active oxygen, which performs the desired bleaching action by oxidation. An activator or a precursor is then usually added to the detergent formulations to promote or catalyze the generation of active oxygen. In the prior art and literature, use of N,N,N′,N′-tetraacetylethylenediamine (TAED) is widely cited as an ecological and extremely efficient activator for peroxide-based materials.

Other previous patents, such as U.S. Pat. No. 5,234,616, disclose the addition of quaternary ammonium-based materials to the detergent formulations containing peroxide salts, which operates by delaying the generation of active oxygen and increasing its yield.

Ultimately, therefore, in the current detergent formulations and especially in those for laundry, a bleach based on inorganic peroxides and in addition a precursor or organic catalyst of such bleach is always provided. However, these products are sensitive to humidity and undergo thermal decomposition reactions which impair their yield and effectiveness and causes possible dangerous situations. Furthermore, the materials forming said bleach are corrosive and irritating to the skin; it is therefore necessary to take measures of external protection that prevent accidental contact of these products with hands or clothes out of the wash water. These protection measures, however, hinder an accurate and rapid dosage of the bleach either because of the risk of accidental spillages (as happens with liquid or granular compounds, which cannot therefore be handled directly without wearing protective gloves) or the impossibility of reducing the dosage below the minimum prepacked quantities (as with solid compounds in tablets or capsules).

The underlying technical problem of the present invention is therefore to provide a bleach packaging which allows direct manipulation by the user, without the need to use gloves or other protective elements, and which prevents any damage to clothing or other objects that can accidentally fall in contact with said agent.

In order to solve this problem, a first object of the invention is therefore to provide an economical and rapidly-applicable coating of a bleach which prevents direct contact with the bleach during the dosage and the subsequent introduction of the bleach into the wash liquid.

A second object of the invention is then to define a packaging shape of the bleach which is small enough to allow a dosage at will by the user, but which does not have the drawbacks of powder dispersion typical of bleaches in granular formulation.

Finally, a third object of the invention is to define a packaging shape of the bleach that can be easily manipulated, in order to facilitate both bleach dosage and rapid recovery in case of accidental spillages.

### SUMMARY OF THE INVENTION

This problem is solved, and these objects are achieved by means of a bleach additive having the features defined in claim 1. Other preferred features of the bleach additive according to the invention are defined in the dependent claims.

Further features and advantages of the bleach additive according to the present invention will in any case be more evident from the following detailed description of some preferred embodiments thereof, illustrated in the attached Examples, provided purely as a non-limiting example of the invention.

### DETAILED DESCRIPTION OF THE PREFERRED EMBODIMENT

According to the present invention, in order to solve the problem described above with an operationally simple and immediately applicable solution, the bleach additive is modified in such a way that it can be extruded in the form of pellets.

Within the present description, the term “pellet” in intended to mean a compacted material in discrete pieces, by means of a process of extrusion under pressure and cutting. The extrusion process can be a batch or continuous process; continuous processes are preferred since it is possible to achieve higher productivity and a better consistency of the quality and shape of the pellet.

Typically, by extrusion process is meant any process by which a material is forced under pressure through a die provided with passage orifices to form continuous cylindrical bodies of extruded material. The extruded material is then cyclically cut, at the extrusion die, as soon as the length of the extruded cylindrical body has reached the desired length for the pellet. Alternatively, the material can be formed as cylindrical bodies of extended length and cut to the desired length in a second step. By pellet length is meant the length of the extruded material between two successive cuts. In the present invention, the extrusion is preferably carried out using an extruder of the type available on the market for the extrusion of plastic materials, e.g. a single screw extruder or a twin-screw extruder.

The shape of the orifices in the die will determine the cross-sectional shape of the extruded pellets; of course, the pellet can have any preferred cross-section. Particularly preferred cross sections of the pellets are the circular ones. Other preferred cross sections include any geometric shape such as triangles, squares, pentagons, hexagons, heptagons, octagons, and non-geometric shapes, such as stars, clovers, crosses, animal shapes, flowers, fruits, and any other desired shape.

The packaging form in pellets of the bleach minimizes the risk of spillage of this product, which is corrosive and irritating for the skin. Furthermore, this form of packaging in discrete pieces of small size, as opposed to tablets or capsules, allows consumers to decide the dosage according to their needs; the dosage operation is quick and easy, as it can be done by bare hands and does not cause fouling in case of accidental spillages. The pellet packaging form offers significant advantages also with respect to granular formulations; the pellets are in fact exempt from the formation of powders, can be dosed in pieces, and therefore do not require measuring containers, occupy less volume because they are strongly compressed and do not exhibit separation of components during transport and storage operations.

According to the present invention, therefore, one or more bleaches, such as inorganic peroxides, and an organic precursor of said bleaches, are mixed with a sticky surfactant, having the ability to coat and bind the bleach. A water-soluble organic polymer is then added to the mixture thus obtained to obtain an extrudable pellet material having the desired and adequately balanced physical properties of hardness and tackiness. Especially, it is necessary that the tackiness is high enough to allow the stable adhesion of the components under the compression action of the extrusion process, but low enough to prevent the pellets from being able to then mutually adhere. Likewise, the final hardness of the pellets must be high enough to maintain the physical shape of the pellets unaltered over time and therefore allow an easy handling thereof, but low enough not to trigger brittleness phenomena which may cause the pellets to break into fragments. Finally, to the composition are added a plasticizer, to regulate the plasticity of the mixture and allow its extrusion, and inorganic salts of alkali metals, to improve the solubility of the pellets and increase the stability of the bleach precursor.

The individual components of the mixture forming the bleach additive of the present invention will now be discussed in detail below. The percentages indicated below for the different components of the formulation are all percentages by weight with respect to the total weight of the formulation.

### Inorganic Peroxides

The bleach additive of the present invention may comprise one or more components based on suitable inorganic peroxides which may include inorganic peroxide salts, such as alkali metal salts, such as sodium salts of percarbonates, perborates, persulphates, perphosphates or persilicates, which produce hydrogen peroxide in aqueous solution.

The sodium percarbonates, corresponding in general to the formula 2Na₂CO₃.3H₂O₂, are particularly preferred due to their greater dissolution rate, and for the high effectiveness with respect to weight. Furthermore, they have a more environmentally friendly behavior and the advantage of generating hydrogen peroxide, while simultaneously releasing sodium carbonate.

On the other hand, the sodium percarbonates have the disadvantage that, in the presence of builders, which can absorb the moisture and then release it again, they tend to decompose with consequent loss of active oxygen and decrease of the bleaching effect. However, in the present invention the stability of sodium percarbonate is improved by the addition of inorganic salts which, thanks to the adhesive nature of the surfactant, coat the bleaching persalt. The extrusion operation fixes the mixture producing a shell effect that further protects the sodium percarbonate from moisture.

The formulation for producing pellets of the invention typically contains from 10% to 80%, and preferably from 15% to 60%, of bleaches based on inorganic peroxides.

### Activators or Precursors

A precursor of an organic peroxidic compound, or an activator of an inorganic persalt, is any organic compound capable of reacting in aqueous solution with a compound containing an inorganic peroxide to give an organic peroxy compound having a bleaching performance at a temperature of 60° C. or lower, at least equivalent to that of a compound containing an inorganic peroxide under the same conditions.

Suitable peroxidic bleach activator compounds can be selected from the group consisting of anhydrides, esters, oximes, chloroformates and cyano compounds. The most preferred classes are the N-acetylated compounds. Particularly preferred activators of peroxide bleaches include N-,N,N′,N′ methylenediamine (TAMD), N-,N,N′,N′ tetraacetyl ethylenediamine (TAED) and N-,N,N′,N′ tetra compounds, such as tetraacetyl hexylene diamine (TAHD). The most preferred persalt activator component is TAED.

The formulation for producing pellets of the invention typically contains from 0 to 15%, and preferably from 0 to 10%, of organic activators of peroxy bleaches.

### Surfactants

Bleaches of the bleach additive of the present invention are coated and mixed with a sticky surfactant or a sticky surfactant system. The surfactant can be selected from anionic surfactants, non-ionic surfactants, and mixtures thereof.

Suitable anionic surfactants typically include alkyl sulfates or alkyl sulfonates, such as alkylbenzene sulfonates. Suitable alkylbenzenesulfonates may include alkali metal salts of C10-C16 alkylbenzenesulfonic acids. The most preferred sulfonates are linear alkylbenzenesulfonates known as “LAS” with an alkyl carbon chain typically comprising from about 10 to 14 carbon atoms. Especially preferred are the linear sodium or potassium alkylbenzenesulfonates, such as the reaction product of benzenesulfonic acid, 4-C₁₀₋₁₃-sec-alkyl derivatives and benzenesulfonic acid, 4-methyl- and sodium hydroxide; as those supplied by Sasol under the trade name Marlon®ARL (EC number: 932-051-8)

Non-ionic surfactants include alcohol ethoxylates, alkyl phenol ethoxylates, carboxylic acids esters, glycerol esters, anhydrosorbitol esters, polyoxyethylene esters, natural fats ethoxylates and the like.

The formulation for producing pellets of this invention typically contains from 2% to 80%, and more preferably from 5% to 60%, of surfactant.

### Inorganic Salts

The bleach additive of the invention furthermore preferably contains water-soluble inorganic salts which act as support material and improve the stability of inorganic peroxide salts. These salts may include alkali metal salts of carbonates, silicates, phosphates, sulfates and aluminosilicates and mixtures thereof.

A preferred salt is an alkali metal sulfate, such as potassium or sodium sulfate, the latter being particularly preferred.

The formulation for producing pellets of this invention typically contains from 5% to 70%, and more preferably from 10% to 60%, of inorganic salts.

### Water-Soluble Polymer

In the bleach additive of the invention a water-soluble polymer is also used to provide the mixture with the desired mechanical properties (plasticity, hardness, and tackiness) necessary to extrude the mixture and produce pellets (or extrudates) provided with satisfactory physical properties.

Selected water-soluble polymers are polyethylene glycols (PEG) or polyacrylates or mixtures thereof. Most preferred are PEGs having an average molecular weight ranging from about 3,000 to about 20,000, which are waxy solids, flakes, or powders.

The formulation for producing pellets of this invention typically contains from 0 to 40%, and more preferably from 0 to 25%, of high molecular weight water-soluble polymer.

### Plasticizer

In one embodiment of the invention, a limited amount of water-soluble polymer is added as a plasticizer or lubricant to promote flow of the mixture, improve filling of the extrusion die and reduce the head-pressure and back-pressure during the extrusion process. Suitable polymers are, without being limited thereto, polyethylene glycols (PEG) having an average molecular weight of less than 700, which appear as viscous liquids.

The formulation for producing pellets of this invention typically contains from 0 to 10%, and more preferably from 0 to 7%, of a low molecular weight water-soluble polymer.

### Perfume

The product may also contain a fragrance to provide a pleasant laundry scent. The fragrance can be added as an oil in free form or as a fragrance in microcapsules (i.e. a liquid fragrance contained in water-soluble microcapsules).

The formulation for producing pellets of this invention typically contains from 0 to 6% and preferably from 0 to 4% of fragrance in free form and from 0% to 5% and preferably from 0% to 3% of fragrance in microcapsules.

### Effervescent Effect

An alternative embodiment of the formulation for producing pellets of the invention provides for the presence of an effervescent effect. Effervescence increases the dissolution rate of the components, further improving the effect of removing stains during the manual pre-treatment, i.e., before putting the laundry into the washing machine.

To give an effervescent effect, solid acid-base pairs must be added. The effervescent pair comprises a solid acid such as malic, fumaric, tartaric, itaconic, maleic, citric or mesaconic acid, and a solid base such as an alkaline or alkaline earth carbonate or bicarbonate which, when dissolved in water, reacts by releasing CO₂ thereby producing the desired effervescence. More preferably, citric acid and sodium carbonate are selected.

The formulation for producing pellets of this invention, with effervescent effect, contains from 0 to 10% of citric acid and from 0 to 20% of sodium carbonate.

### Optional Ingredients

An additional ingredient of the formulation for producing pellets of the invention consists of micro-silica (also known as silica fumes or fumed silicas). Micro-silica is a highly absorbent material, which functions as flow coadjuvant and as desiccant. Commercially available micro-silica can be found under the Aerosil (Degussa) or Cabosil (Cabot) trademarks. Alternative desiccants may be carrageenan or cellulose such as carboxymethyl cellulose or hydroxymethyl cellulose.

Another additional ingredient of the formulation to produce pellets of the invention consists of a chelating agent, which may be included in the formulation to reduce the formation of lime-scale. Preferred chelating agents according to the present invention can be selected from the group consisting of amino carboxylates, amino phosphonates, polyfunctional substituted aromatic chelating agents and mixtures thereof, all preferably in their acidic form. In the preferred embodiment of the present invention, the chelating agent is ethylenediaminetetraacetic acid (EDTA) and water-soluble salts thereof, such as alkali metal salts, ammonium salts, substituted ammonium salts and mixtures thereof. The chelating agent may be present in an amount of from 0 to 5%.

The above-mentioned optional components and other components known for use in stain removal compositions and laundry detergent compositions, such as water-swellable polymers, fillers, dyes, optical bleaches, pH adjusting agents, hydrotopes and the like, can be added in total from 0 to 15%, and more preferably from 0 to 10% of the formulation to produce pellets of the invention.

### EXAMPLES

The present invention is further illustrated by the following non-limiting examples.

### Example 1

| COMPONENTS | % w |
|---|---|
| Sodium percarbonate (2Na₂CO_{3•}3 H₂O₂) | 30.00 |
| TAED | 5.50 |
| Marlon Arl | 21.93 |
| Sodium sulfate | 29.08 |
| PEG 9000 | 10.80 |
| PEG 400 | 1.70 |
| Dye | 0.01 |
| Perfume | 0.98 |

### Example 2

| COMPONENTS | % w |
|---|---|
| Sodium percarbonate (2Na₂CO_{3•}3 H₂O₂) | 30.00 |
| TAED | 5.50 |
| Marlon Arl | 20.43 |
| Sodium sulfate | 19.08 |
| Sodium carbonate | 10.00 |
| PEG 9000 | 10.80 |
| PEG 400 | 1.70 |
| Dye | 0.01 |
| Aerosil | 1.50 |
| Perfume | 0.98 |

### Example 3

| COMPONENTS | % w |
|---|---|
| Sodium percarbonate (2Na₂CO_{3•}3 H₂O₂) | 30.00 |
| TAED | 5.50 |
| Marlon Arl | 20.43 |
| Sodium sulfate | 14.08 |
| Sodium carbonate | 10.00 |
| Citric acid | 5.00 |
| PEG 9000 | 10.80 |
| PEG 400 | 1.70 |
| Dye | 0.01 |
| Aerosil | 1.50 |
| Perfume | 0.98 |

The components of the foregoing examples are thoroughly mixed in a conventional mixing apparatus and then extruded. It is assumed that the final composition of the pellet is equal to the composition of the initial formulation, before the extrusion process.

In a preferred embodiment of the present invention the pellet will have a diameter (i.e. a maximum width of its cross section) between 1.0 mm and 30.0 mm, preferably between 2.0 mm and 17.0 mm, and the pellet length will be between 0.5 mm and 30 mm, and preferably between 2 mm and 15 mm.

It is understood, however, that the invention should not be considered limited to the arrangements illustrated above, which represent only exemplary embodiments thereof, but that different variations are possible, all within the reach of a person skilled in the art, without thereby departing from the protection scope of the invention, which is only defined by the following claims.

1) A water-soluble bleach additive for laundry detergents and for surface cleaning detergents, of the type comprising a bleach agent, an activator of the bleach agent and a builder, characterised in that it furthermore comprises a sticky surfactant and in that it is formed in extruded pellets.

2) The bleach additive as in claim 1, wherein said sticky surfactant is selected from anionic surfactants, non-ionic surfactants, and mixtures thereof such as alkyl sulfates or alkyl sulfonates, as alkylbenzene sulfonates.

3) The bleach additive as in claim 2, wherein said sticky surfactant is a linear sodium or potassium alkylbenzene sulfonate, having a straight chain comprising from 10 to 14 carbon atoms.

4) The bleach additive as in claim 2, containing between 2% and 80%, and more preferably between 5% and 60%, of said sticky surfactant.

5) The bleach additive as in claim 1, furthermore comprising a water-soluble polymer with a high molecular weight, selected from polyethylene glycols (PEG) or polyacrylates or mixtures thereof.

6) The bleach additive as in claim 5, wherein said water-soluble polymer with a high molecular weight is a polyethylene glycol (PEG) having an average molecular weight ranging between about 3,000 and about 20,000.

7) The bleach additive as in claim 5, containing between 0 and 40%, and more preferably between 0 and 25%, of said water-soluble polymer with a high molecular weight.

8) The bleach additive as in claim 1, furthermore comprising a water-soluble plasticizer consisting of a polyethylene glycol (PEG) with average molecular weight below 700.

9) The bleach additive as in claim 8, containing between 0 and 10%, and more preferably between 0 and 7%, of said plasticizer.

10) The bleach additive as in claim 1, wherein said bleach agent is selected among inorganic peroxides and inorganic peroxide salts, preferably alkali metal salts, such as sodium salts of percarbonates, perborates, persulfates, perphosphates o persilicates.

11) The bleach additive as in claim 10, wherein said bleach agent is sodium perborate.

12) The bleach additive as in claim 10, containing between 10% and 80%, and preferably between 15% and 60%, of said bleach agent.

13) The bleach additive as in claim 1, wherein said activator of the bleach agent is selected between anhydrides, esters, oximes, chloroformates and cyano compounds, in particular N-,N,N′,N′ methylene diamine (TAMD), N-,N,N′,N′ tetraacetyl ethylene diamine (TAED) and N-,N,N′,N′ tetra compounds, such as tetraacetyl hexylene diamine (TAHD).

14) The bleach additive as in claim 13, wherein said activator of the bleach agent is N-,N,N′,N′ tetraacetyl ethylene diamine (TAED).

15) The bleach additive as in claim 13, containing between 0 and 15%, and preferably between 0 and 10% of said activator of the bleach agent.

16) The bleach additive as in claim 1, furthermore containing a solid acid-base couple apt to produce an effervescent effect in contact with water.

17) The bleach additive as in claim 16, wherein said solid acid-base couple consists of between 0 and 10% of citric acid and of between 0 and 20% of sodium carbonate.

18) The bleach additive as in claim 1, furthermore containing a fragrance in free form and/or fragrance in microcapsules.

19) The bleach additive as in claim 18, containing between 0 and 6% and preferably between 0 and 4% of fragrance in free form and between 0% and 5% and preferably between 0% and 3% of fragrance in microcapsules.

20) The bleach additive as in claim 1 wherein said pellet has a diameter between 1.0 mm and 30.0 mm, preferably between 2.0 mm and 17.0 mm, and a length between 0.5 mm and 30 mm, and preferably between 2 mm and 15 mm.
